(19) United States
(12) Patent Application Publication
(10) Pub. No.: US 2021/0391769 A1
(43) Pub. Date: Dec. 16, 2021

(54) Compressed Air Accumulation System For Power Generation

(71) Applicant: Eugene J. Picchi, Boca Raton, FL (US)

(72) Inventor: Eugene J. Picchi, Boca Raton, FL (US)

(21) Appl. No.: 17/313,871

(22) Filed: May 6, 2021

Related U.S. Application Data
(63) Continuation-in-part of application No. 16/903,109, filed on Jun. 16, 2020, now abandoned.

(51) Int. Cl. H02K 7/18; F15B 1/02

(52) U.S. Cl. CPC H02K 7/1853; F15B 1/024

(57) ABSTRACT

A compressed air generation system that provides compressed air for a variety of applications including generation of electricity. The a system for accumulating and storing compressed air that is later used for a variety of applications including energy generation. The system uses mechanical air pumps that are activated when vehicles, including cars and buses, pass over air pumps imbedded in the road surface. Alternative embodiments use air compression pumps to store compressed air when the moving vehicles, such as trains, pass over railroad ties. The compressed air is fed into air accumulators that are used to produce clean electrical energy.

### CROSS-REFERENCE TO RELATED APPLICATIONS

This application is related to, and claims the benefit of, the co-pending non-provisional patent application entitled “ Compressed Air Accumulation System For Power Generation”, filed Jun. 16, 2020, bearing U.S. Ser. No. 16/903,109 and naming Eugene J. Picchi, the named inventor herein, as sole inventor, the contents of which is specifically incorporated by reference herein in its entirety.

### BACKGROUND

### Technical Field

This invention relates in general to electric power generation, and more particularly it relates to electric power generation using stored compressed air from a compressed air accumulation system.

### Background of the Invention

As energy sources become scarcer, particularly hydrocarbon-based sources, there is a growing need for renewable energy sources to replace nonrenewable sources. In addition, there is also a need to create nonpolluting energy sources to address growing concerns about global warming. To this end a variety of renewable energy technologies have been, and are being, developed. Renewable energy sources include a variety of technologies, such as solar, wind, geothermal, etc. Each of these energy sources provide useful contributions to the ongoing work related to protection of the environment, and replacement of non-renewable energy sources such as oil or coal.

One field of research regarding energy conservation, renewable resources, and providing clean non-polluting energy which has been overlooked in large part has been the use of wasted energy generated by normal day-to-day activities. It would be desirable to have a method of accumulating energy from a variety of machine movements and mechanical activity that would otherwise be expended during a variety of normal activities.

While the prior art has provided many approaches to energy generation, it has failed to address an important source of energy that could be easily acquired at minimal cost, and which would produce renewable energy with minimal or no pollution or impact on the environment.

### SUMMARY OF THE INVENTION

This invention provides a system for accumulating and storing compressed air that is later used for a variety of applications including energy generation. The system uses mechanical air pumps that are activated when vehicles, including cars and buses, pass over air pumps imbedded in the road surface. Alternative embodiments use air compression pumps to store compressed air when the moving vehicles, such as trains, pass over railroad ties. The compressed air is fed into air accumulators that are used to produce clean electrical energy.

### BRIEF DESCRIPTION OF THE DRAWINGS

FIG. 1 is a block diagram of a preferred embodiment of the invention illustrating the flow air from accumulation devices to an air accumulator tank that supplies pressurized air to a turbine generator.

FIG. 2 is an illustration of a preferred embodiment of a roadway generator used to generate air pressure.

FIG. 3 is an illustration of a preferred embodiment of a roadway generator used to generate air pressure shown with an automobile driving over it.

FIG. 4 illustrates a preferred embodiment of bus generator that generates air pressure from regenerative braking systems on a bus or other vehicle.

FIG. 5 illustrates a preferred embodiment of a wave and tidal generator for generating air pressure.

FIG. 6 illustrates a preferred embodiment of an air generator incorporated into a railroad car.

FIG. 7 illustrates a preferred embodiment that uses utility poles as temporary compressed air storage devices.

### DETAILED DESCRIPTION OF THE PREFERRED EMBODIMENT

Prior to a discussion of the figures, a brief overview of the invention will be presented. The invention is a system that uses otherwise wasted energy from the motion of a variety of conventional devices to generate and store compressed air for use as an energy source. Motion from a variety of devices, such as automobiles, trucks, buses, trains, etc. to activate air pumps in accumulator devices create compressed air that is stored for later use. The air pumps in the accumulator devices are attached via air conduits to compressed air storage containers that hold compressed air that is fed into a central location to provide stored energy for use in powering air-powered electrical generators/turbines. The compressed air can be used as a direct energy source, such as for direct propulsion of vehicles, or as an indirect energy source to drive generators that produce electricity. For ease of discussion, the system will be referred to as the “airwatt engine.” The airwatt engine is not a competitor to current energy sources, such as oil, biofuels, hydrogen fuel cells, etc. Rather, it complements those systems because the airwatt engine generates additional energy from currently wasted energy that is a by-product of those same prior art systems. Currently, much of the wasted energy comes as a by-product from fossil fuel. The more fossil fuel consumed, the more potential energy is available to drive the airwatt engine. In the future, energy needed to produce hydrogen for hydrogen powered vehicles can also come from the airwatt engine.

Just as electricity is generated from dams that utilize the motion of water moving through the dam, the airwatt engine generates electricity by utilizing the motion of objects, such as cars, truck, buses, etc., rolling over air pumps position on road surfaces. This is how it works: air is pumped from various sized, purpose made air compressor pumps located throughout an average city, millions of air compressors collectively send huge volumes of air into a grid of air hoses. The airwatt engine is connected by air hose lines coming from a multitude of locations, such as houses, buildings, roadway intersections and parking lots in a city. The airwatt system is powered from wasted energy captured from everyday activities of society that until now has been invisible, and thus thrown away. Activities ranging from driving cars, trucks and trains, etc.

The captured energy is collected by pumps driven by movement of vehicles, etc. The output of the air pumps is connected to air hoses that are routed along the paths of electric power lines and other existing infrastructure. That air is then routed to the airwatt engine. The airwatt engine uses the air to powers turbines directly, or to create a water flow, to make electricity. The electricity generated by the airwatt engine then supplies power for its desired uses.

In the preferred embodiment, the air hoses used by the invention piggy-back on the existing power grid infrastructure of telephone lines and electric power distribution poles, threading through city water, storm and sewage systems, gas lines traveling under, over and alongside roadways. One way check valves permit air flow in only one direction: toward the airwatt engine. Air pumps distributed around a city send compressed air along small air hoses that feed a main airline pipe or hose that travels to the location of the airwatt engine. In one preferred embodiment, the airwatt engine is located offshore. However, those skilled in the art will recognize that it can be in any type of water body, such as a natural lake, a manmade lake, the ocean, etc. The depth of the airwatt engine can vary depending on the size of the engine, the available depth of water, etc. the airwatt engine over two thousand feet deep.

To prevent backflow of air in the air hose system, one way check valves are placed on every pump connected to the system. The air is forced to converge and compress into the main pipeline that steadily delivers millions of cubic feet of air to the airwatt engine.

In the preferred embodiment, the air is cleaned at optional filter stations at predetermined points in the air hose grid until it reaches the final destination, the airwatt engine. The airwatt system will filter and clean polluted air before it is released back into the atmosphere from the airwatt engine exhaust. The air will also be cooler when exhausted back into the atmosphere because the air pipe line is laid out on the ocean floor for substantial distances in relatively cold water. The cold air exhaust may have an impact on global warming.

The airwatt engine produces energy with an air-filled vessel that is anchored on ocean floor. This air-filled vessel has a controlled ascent until it is just under ocean surface. The vessel then releases its air and descends to ocean floor and locks down into a cradle or gantry where it fills with air to become ready to ascend after other air-filled vessels begin to descend. During that up and then down motion of the air-filled vessel, the force or energy is captured and converted into torque that turns a shaft. This shaft connects to a series of gears that increases the revolutions of the rotating shaft that then powers a generator. Imagine a multiple cylinder reciprocating engine block two thousand feet tall made of concrete. In the preferred embodiment, there is a hollow piston head in each cylinder, with each piston head the size of a ten-story building. The size and volume of the cylinder will be determined in proportion to the horsepower needed to power and sustain a constant source of torque turning the gears of an electric turbine generator plant.

In one embodiment, the pistons are mechanically connected to a spiral shaft that vertically passes through a stationary chuck in the center of the piston. As the hollow air-filled piston slowly rises at a controlled speed, it rotates the vertical spiral shaft that passes through the center of piston head. The piston and is on a fixed track provided inside the lining of the walls of the cylinder shaft. This forces the air-filled cylinder to remain stationary as it rises upward to surface. Rather, as the air-filled piston ascends, it forces the spiral shaft to turn. The piston head and chuck always remaining stationary. The size of the shaft can vary depending on the amount of energy needed for a given city. For example, in large installations, the shaft can be a thousand or more feet long. The energy of the rising air-filled piston rotates the spiral shaft. As the spiral shaft is forced to spin it provides the torque equal to the horsepower of the rising air-filled piston. The spiral shaft connects to a main crankshaft that the other pistons share. Those pistons are filled with air and ready for launch as the empty water filled pistons descend back into their own launch cradles, while in the launch cradle gantry they refill with air coming from the city.

The main crankshaft rotates uninterrupted as the gears shift smoothly to the next piston to be launched. The air-filled piston rapidly expels its air exhaust at the top of the tower shaft. Now the empty water filled steel piston descends. Energy can now be made from the falling weight of the water filled steel piston. A shift direction gear in the chuck allows spiral shaft to rotate same direction as it did when rising. The number of threads on the spiral shaft controls the speed of assent or decent. As the piston ascends, the upward threads can be more dense or closer together to stretch the amount of time it takes to rise, thus extracting more power from the rising force of the trapped air in the piston. The spiral piston shafts are connected to a common main shaft that is connected to a step up gear transmission that will convert the slow turning shaft to a high revolution spinning shaft that preferably rotates at about 3600 rpm, those are the rpm's needed to spin a fly wheel that weighs about 56 tons. The land-based generator in Port Everglades, Fla. uses that method. The turbine generators can be located on top of the structure on the surface of the water body. The generators can also be located on land, either incorporated into existing power plants or independent of them. However, a long drive shaft coming from the airwatt engine would be necessary. The shaft could require a substantial length.

The walls of the cylinder need not be solid or contained. They could be tall columns of scaffolds or crane books. They could also be concrete cylinder. Whatever design that structural engineers deem more efficient and durable. These columns and the pistons in them are anchored into a giant weighted concrete base that is embedded into a deep lake/ocean floor. The base, depending on the number of cylinders, could be as large as twenty acres in area.

A preferred method of construction is to use a series of concrete hulls (caissons) that will interlock and assemble as a base that will facilitate all the apparatus needed to operate the airwatt engine. The base can be as large as a ten story square cube. Each cube that makes up the whole base would be about a half acre in size. After each hollow section of the base is tugged out to sea, the concrete hull will be filled with water as it descends to its designated position. This will be repeated till platform base is complete. The sections will be cork screwed or augured firmly into ocean floor to prevent any chance of the base lifting or shifting. Then the hollow base can be filled with water or sand to weight the base firmly to the ocean floor.

Once the base is completed, it provides a firm foundation to build ten towers that will contain the hollow pistons. The piston towers are aligned on the surface of the base. There is a common shaft lying horizontally inside the base. It is a giant crankshaft. It is the common shaft that is connected to all the vertical piston cylinder spiral shafts. The crankshaft rotates a drive shaft that stretches along the ocean floor toward the closest existing onshore coal, oil or other electricity generator plant. The drive shaft ties into a giant transmission gear house, configured like the transfer case on a four-wheel drive truck. The transmission converts the torque from the slow turning drive shaft to the high speed revolutions needed (3600 rpm's) to power plant turbines.

The system also uses air accumulators can be in fixed locations, or mounted onboard vehicles of any type. Fixed location accumulators are preferably placed in high-traffic locations to maximize their efficiency. An example of a fixed location accumulator would be a spring-loaded pressure plate installed in pavement that could be activated whenever a vehicle is driven across it. When this happens, the pressure plate is moved by the weight of the vehicle and drives a pump that generates a small amount of air that is input to an air accumulation tank. A network of pressure plates generates a steady flow of air that is fed into one or more air accumulation tanks. The air accumulation tanks can operate turbine generators directly, feed air to larger central accumulation thanks, or provide a compressed air source for other applications.

Probably the most consistent source of air compression supply for the airwatt engine will be the water line generator. This device will be retrofitted into the water lines going into homes, businesses and all other buildings using fresh water. Municipal water systems are distributed via pipelines under pressure provided by either electric or diesel pumps. The pressure causes the water to flow rapidly out of our faucets, toilets etc. There is a point were the energy used to make the water flow separates from the energy created from the weight of the water moving. The individual water meters used to measure water usage are a good example of how to extract energy from this hidden source of potential energy use. The invention envisions a new kind of water meter that not only measures water use but also produces energy to turn a small air compressor built into the meter. The air compressors can be implemented using commercially available portable battery powered air compressor pumps used to inflate automobile tires. They are small and durable and would last decades before wearing out. With the proper gear ratio, the flow of water passing over small paddles inside the pipe would power the compressor each time water is used in a house or business. The compressor would have an air hose coming out of it and an air intake snorkel. The hose would be buried under ground and routed to the base of the nearest telephone pole. From there the hose would go up the pole and be latched onto the other existing telephone, electric or cable TV lines. This is repeated for every house and building in the city. At every inline pump there is a one way check valve that would prevent any blow back of pressure. The direction of this air is toward the airwatt engine.

As for the gearing of this air pump, the gear ratios can vary so long as energy is extracted from the weight of the moving water as opposed to taxing any energy that is used from the city pumps to pressurize the water pipe grid. Once that balance has been defined, the waterline generator will be capturing energy that ordinarily would have been wasted. These built in pumps can vary in size depending on the gauge of the pipes in the water line grid. For example, pumps can also be retrofitted or redesigned to fit into a home swimming pool pumps or hot tubs. The force of the water flow can produce substantial volumes of air on a daily basis. Since the water used in pool pumps etc. is from a private citizen, incentives to install these extra air compressor pumps could come as an energy credit toward there electric bill, installing these extra pumps throughout their homes and businesses would be a savings in the long run. There are millions of private pools. Likewise, larger pumps can be installed in the main water lines throughout the city.

The water in municipal water pipelines is always under pressure. When a faucet is opened, the water flow provides a source of energy. The amount of air pumped from each individual inline air pump seems insignificant, but the combined effect of millions of these pumps contributing their small amount of air production during the day. For example, billions of laundry loads washed, lawns watered, cars washed, baths, showers etc., can all deliver air to the airwatt engine.

Another alternative embodiment uses a train track generator. This embodiment extracts energy from the movement of train traffic. Hundreds of thousands of these devices would be retrofitted into the railroad infrastructure. The train cars and the train tracks are retrofitted with devices that would simultaneously produce electric power three separate ways. The first method of energy production is the compression of air that is sent into the airline grid to the airwatt engine. The second method is the production of electricity in real time. Electricity is generated as the train passes over the train track generator device that is built into the railroad track. The real time electricity is then sent into the electric power grid for that region that the train is passing through. The third method of electric power production comes from hydraulic pressure accumulator tanks that are stored under ground or above ground off the side of the tracks. These tanks would are capable of storing between 5000 and over 10,000 plus psi. As trains pass through a community, energy can be stored in these tanks. The pressurized air stored in these tanks would power hydraulic pump motors that would power on site electric generators. This component in the train track generator system would be activated from signals sent from the electric companies control room. The pressure would be released remotely on demand as needed preventing brown outs or just supplementing power into the grid, there are 180,000 miles of train track in America, and hundreds of thousands more worldwide.

In addition, energy can also be extracted from a regenerative braking machine retrofitted onto several different kinds of railroad cars (empty tanker cars in particular). When they have stopped moving, stored energy is offloaded from cars at points of origin, destination and at strategic points along the railroad track whenever the train has stopped during its route. This energy is transferred to airwatt engine. Railroad can be retrofitted to become energy production machines. Regenerative braking devices are fitted into the undercarriage of many kinds of eligible train cars. They must have room on some part of the train car chassis to accommodate the recapturing pumps and gear boxes necessary to store compressed air in onboard air tanks. These tanks would preferably be under the railroad car in various locations. This process would also apply to tanker cars of all types. Tanker cars that carry both nonhazardous and hazardous material such as acid, solvents, tar, oil, chlorine etc., will always have to travel dead head to their place of origin to reload. In most situations, the now empty tanker car is transported thousands of miles to its point of origin. If the tanker is fitted with a re-generative air compression pumping system, its stored compressed air can be off loaded into the airline grid that feeds the airwatt engines that are in the vicinity of the trains route the pollutants that would still be mixed in with the compressed air would be filtered out along its way through the airline grid. Thus cleaning the tankers pollutants before they escape into the atmosphere when they are reloaded with the same or other chemicals.

Another embodiment uses roadway generators, imbedded in roadways, that are run over by automobile and truck traffic in cities and suburbs. As the roadway generators are run over, energy is extracted in three separate ways. First, electricity is generated in real time with electric generators that send electricity into the power grid as the vehicles run over the device. Second, air compressors are powered as vehicles run over the roadway generators. The compressed air is sent to the airwatt engine via the airline grid that would be established at the time the roadway generator comes on line as an energy producing machine. The third method that the roadway generator produces electricity is hydraulic energy. Hydraulic pumps store hydraulic pressure in underground and above ground accumulators. The above ground accumulators would be retrofitted into the large hollow metal utility poles that usually are holding up streetlights and traffic lights etc. As traffic slows down or just stops, the hydraulic pumps that stored pressure in these accumulators would release their pressure on demand from a central control center when needed. The stored hydraulic pressure powers the same hydraulic pumps that are now hydraulic motors. These hydraulic motors turn electric generators that send electric power directly into the city electric power grid. Air compressors would also be powered depending on which was the more efficient power source needing replenishment.

One more advantage the roadway generator can be of service is to independently power traffic lights at each intersection.

Preferably, the roadway generator does not take away any performance or energy from the vehicle. This is accomplished by placing the roadway generator at the corners of intersections. It is at that moment a car is braking to slow down to make a right or left hand turn anyway. The intention is to take advantage of the car as its weight pushes down while slowing the car down without causing it to spend any energy to power the roadway generators. The generator is designed to harvest otherwise wasted energy, not to cause energy to be transferred from the cars fossil fuel energy. An intersection where a car comes to a full stop is a good example of this energy harvest. Likewise, heavy duty roadway generators can be used to capture the full potential of heavy trucks, tractor trailers etc, truck stops and truck depots are potential energy bonanzas. Because of the mix of vehicles on common roads, sensors can be built into the roadway generators to detect the weight of the vehicle and automatically adjust gears in its gear box to take full advantage of the weight it is about to be run over with, such as a light weight car or 20 ton truck. These sensors would be in the roadway preceding the roadway generator so as to be able to determine the adjustment before each different kind of light or heavy vehicle passes over the roadway generators. In addition, the roadway generator device can be used on private properties and businesses such as shopping malls, sport stadiums, factories, universities, truck stops, hospitals, fuel stations, parting garages and much more.

Having discussed the invention in general, we turn now to a detailed discussion of the drawings.

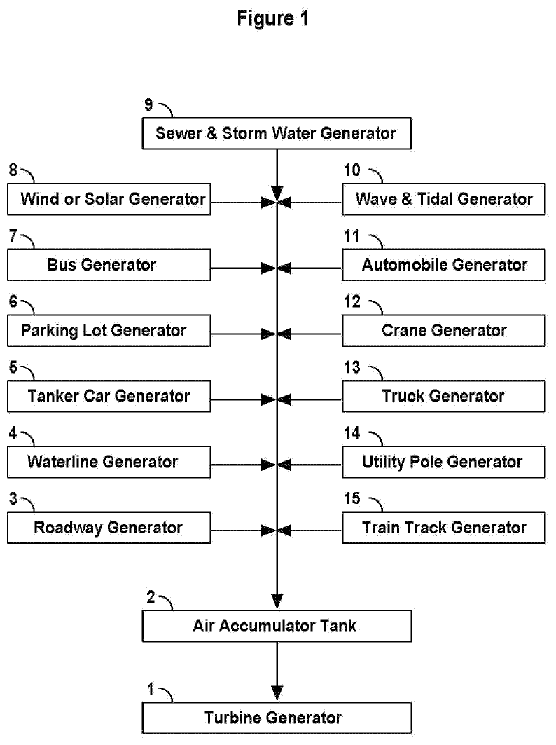

Regarding FIG. 1, this figure illustrates how a variety of air accumulation devices can be used to supply air pressure to an accumulation tank. As can be seen, a variety of inputs 3-15 can be used to provide air pressure to an air accumulator tank 2. Compressed air from the air accumulator tank 2 is output to the turbine 1 which generates electricity. Any number of devices can be used to input air to the air accumulator tank 2. By way of illustration, the air accumulation devices illustrated in this figure show a roadway generator 3, a water line generator 4, a tank car generator 5, a parking lot generator 6, a bus generator 7, the wind or solar generator 8, a sewer and storm water generator 9, a wave and tidal generator 10, and automobile generator 11, a crane generator 12, a truck generator 13, a utility pole generator 14, and a train track generator 15. Those skilled in the art will recognize that the foregoing list is only exemplary in nature, and the principles of the invention can be applied to any device in motion.

As shown in the figure, any number of disparate air accumulation devices 3-15 can be used in combination with one another you supply one or more air accumulator tanks 2. An advantage provided by the invention is that relatively small flows of air pressure can be accumulated from many sources to provide a central high-pressure supply of air in an air accumulator tank 2.

Those skilled in the art will recognize that using a turbine generator 1 is only one application that can be provided by the system. Once high-pressure air is accumulated in the air accumulator tank 2, that air can be used for a variety of purposes. For example, lets take the situation where a gas station installs a roadway generator 3 (discussed in more detail below) at the entrance to the gas destination. As cars drive in and out of the gas station, they drive over the roadway generator 3 and force air into an air accumulator tank 2 in the gas station. As cars enter and leave the gas station over the course of the day, the air accumulator tank 2 is constantly being replenished with high-pressure air. As a result, mechanics working on automobiles using air power tools had the benefit of a high- topressure air supply that does not require an electrical or gas-powered generator to maintain pressure. This provides a cost-savings to the gas station in that they no longer have to incur the cost of actively maintaining their pressure for their tools and equipment. In addition, the local generation of air pressure in this manner incurs no environmental costs since no fuel is consumed to maintain air pressure. The energy to generate the air pressure comes solely from cars rolling across the roadway generator 3.

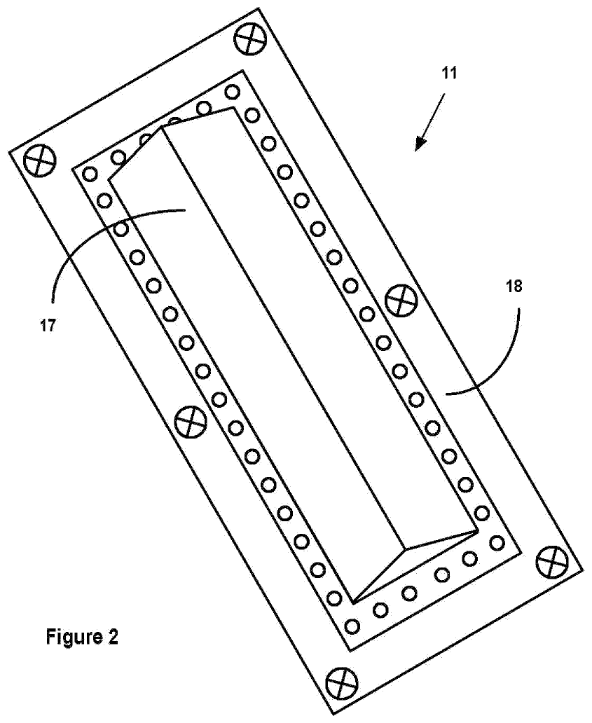

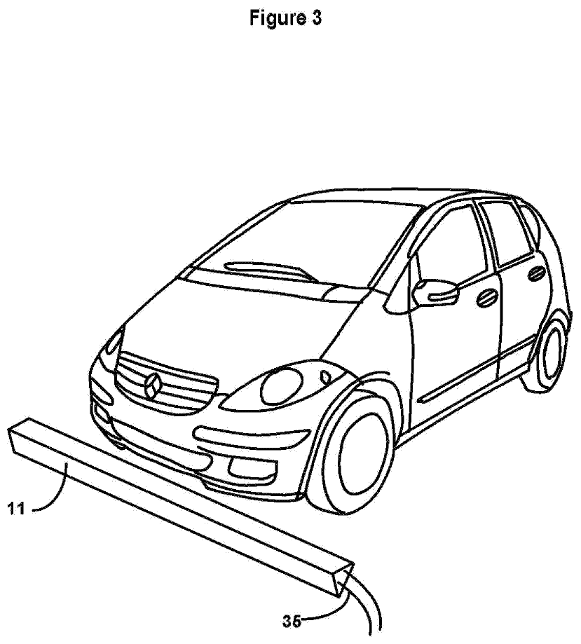

FIG. 2 is a plan view of a preferred embodiment of a roadway generator 11 used to create compressed air. This figure illustrates the compression mechanism 17 and the cover 18. The cover 18 is secured to the roadway surface at ground-level. One of vehicles tire passes over the compression mechanism 17, the weight of the vehicle forces the compression mechanism down which in turn drives an air pump. Pressurized air is then pumped by the compression mechanism into air conduit 35 (shown below in FIG. 3).

FIG. 3 illustrates the embodiment of FIG. 2 that illustrates a car driving over the roadway generator 11. For ease of illustration, the air conduit 35 is shown above ground. However, those skilled in the art will realize that in practice, air conduit 35 would be underground to avoid damage.

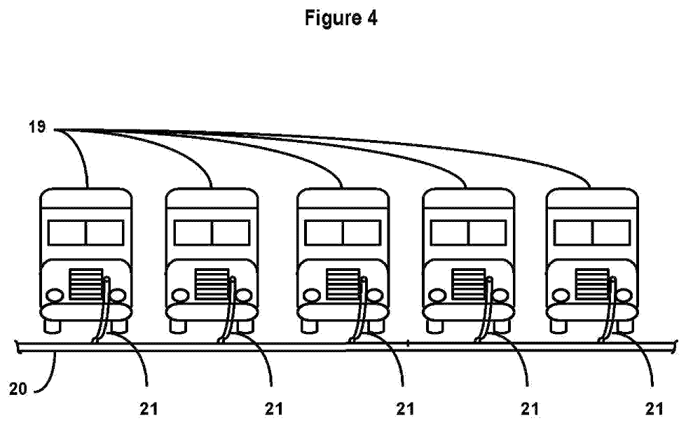

FIG. 4 illustrates a preferred embodiment of bus air generation that generates air pressure from regenerative braking systems on buses 19 or other vehicles. During use, the regenerative braking system on the bus 19 would drive an air pump but compressed air in storage tanks on board the bus 19 or other vehicle. At the end of a day or shift, the process 19 would be connected to air output conduits 21. In turn, the air output conduits 21 would input the compressed air and into a central storage tank or other energy generation device, such as the turbine generator, via air accumulation conduit 20.

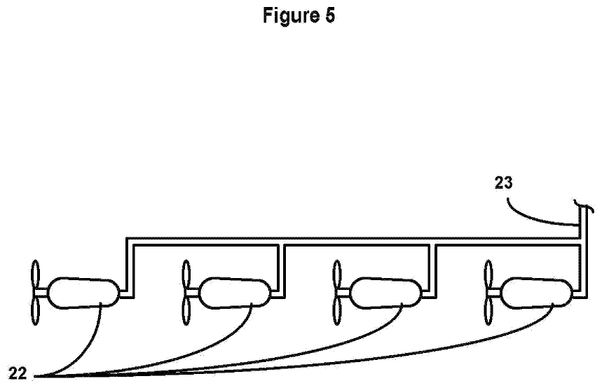

FIG. 5 illustrates a preferred embodiment of a wave and tidal generator 22 for generating air pressure. Multiple tidal generators 22 produce energy to drive an air compressor that feeds compressed air to air accumulation conduit 23.

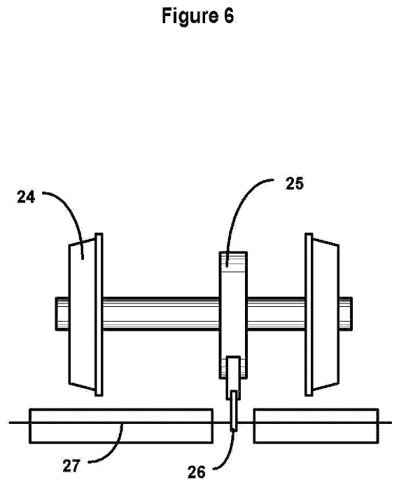

FIG. 6 illustrates a preferred embodiment of an air generator incorporated into a railroad car. This figure shows an air compressor 25 that is attached to the axle of a rail wheel assembly 24. As the railcar moves down the track, an extension 26 that extends from the air compressor 25. As the extension 26 contacts the rail ties 27, it spins to drive the air compressor 26. Rail tie 27 is shown with a missing portion of the rail tie 27 to more easily illustrate the extension 26. Likewise, the air pressure generated by the compressor 25 is stored in a storage compartment (not shown).

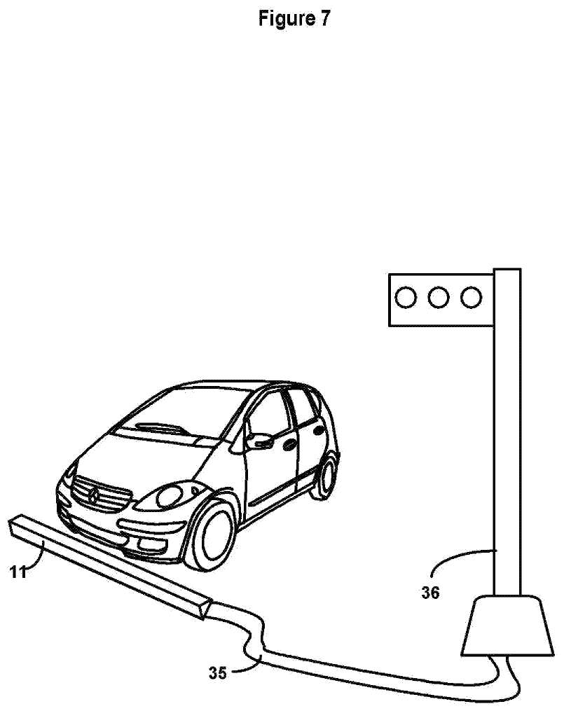

FIG. 7 illustrates a preferred embodiment that uses poles 36 as temporary storage devices. The poles 36 may be traffic signal poles, as shown, or, light poles, etc. An advantage of using poles 36 is that they add no new infrastructure to clutter up the streets. The poles 36 can be installed as older polls are removed and replaced or new streets and intersections are built. Likewise, some pre-existing poles may be retrofitted depending on their structure. The preferred embodiment envisions the poles 36 having an internal storage tank for storing compressed air. Compressed air would be fed into the storage tank from a roadway air generator 11, as discussed above, and later output to a centralized collection point.

While specific embodiments have been discussed to illustrate the invention, it will be understood by those skilled in the art that variations in the embodiments can be made without departing from the spirit of the invention. The generators used to input air into the air accumulators can vary widely based on the type of vehicle or device that is producing the air pressure. The air accumulators can vary depending on whether they are the fixed or mobile output of the air accumulator tank can be used to provide power for a wide variety of purposes, from pneumatic hand tools, as to massive our generation systems. The application, the invention shall be limited to the scope of the claims.

I claim:

1. A compressed air generator, comprising:
a compression device which, when compressed, forces air to an air accumulation device; and
means to drive an electrical generator with compressed air from the air accumulation device.
